(19) United States
(12) Patent Application Publication
(10) Pub. No.: US 2023/0237223 A1
(43) Pub. Date: Jul. 27, 2023

(54) SYSTEMS AND METHODS FOR ESTIMATING WELL INTERFERENCE ON A TARGET WELL FROM OTHER POTENTIAL WELLS IN A SUBSURFACE VOLUME OF INTEREST

(71) Applicant: CHEVRON U.S.A. INC., San Ramon, CA (US)

(72) Inventors: Yunhui Tan, Katy, TX (US); Baosheng Liang, Houston, TX (US); Jiehao Wang, Missouri City, TX (US); Gerardo Jimenez, Houston, TX (US); Ben Madara, Pearland, TX (US); Margaretha C.M. Rijken, Houston, TX (US); Yuguang Chen, Bellaire, TX (US)

(21) Appl. No.: 17/585,268

(22) Filed: Jan. 26, 2022

(51) Int. Cl. G06F 30/27; E21B 49/00; E21B 41/00

(52) U.S. Cl. CPC G06F 30/27; E21B 49/00; E21B 41/00; E21B 2200/20; G06F 2113/08

(57) ABSTRACT

Methods, systems, and non-transitory computer readable media for estimating well interference on a target well from other potential wells in a subsurface volume of interest are disclosed. Exemplary implementations may include: obtaining well implementation data for the target well and the other potential wells; obtaining estimated reservoir volumes as a function of position; generating well overlap between the target well and the other potential wells; generating extraction interference probabilities; generating a representation of a well layout as a function of position in the subsurface volume of interest; and displaying the representation.

### RELATED APPLICATIONS

The disclosures of “ARTIFICIAL LEARNING FRACTURE SYSTEM AND METHOD FOR PREDICTING PERMEABILITY OF HYDROCARBON RESERVOIRS” U.S. patent application Ser. No. 17/039,403, filed Sep. 30, 2020 and “ARTIFICIAL LEARNING FRACTURE SYSTEM AND METHOD FOR PREDICTING PERMEABILITY OF HYDROCARBON RESERVOIRS” U.S. Patent Application No. 62/909,029, filed Oct. 1, 2019, are hereby incorporated by reference herein.

### FIELD OF THE DISCLOSURE

The present disclosure relates to systems and methods for estimating well interference on a target well.

### SUMMARY

Implementations of the disclosure are directed to systems and methods for estimating well interference on a target well.

An aspect of the present disclosure relates to a computer-implemented method for estimating well interference on a target well from other potential wells in a subsurface volume of interest. The method may be implemented in a computer system that includes a physical computer processor, a graphical user interface, and non-transient electronic storage. The method may include a number of steps. One step may include obtaining well implementation data for the target well and the other potential wells in the subsurface volume of interest. Another step may include obtaining estimated reservoir volumes as a function of position in the subsurface volume of interest. Yet another step may include generating well overlap between the target well and the other potential wells based on at least the well implementation data. Another step may include generating extraction interference probabilities based on at least the estimated reservoir volumes and the well overlap. The extraction interference probabilities may each specify an effect one or more of the other potential wells have on productivity of the target well. Yet another step may include generating a representation of a well layout as a function of position in the subsurface volume of interest using visual effects to depict at least a portion of one of the well implementation data, estimated reservoir volumes, and well overlap. The well layout may correspond to one of the extraction interference probabilities that is below an interference threshold. Another step may include displaying the representation.

In implementations, the estimated reservoir volumes may be generated based on at least productivity cut off values and permeability values for the target well and the other potential wells in the subsurface volume of interest.

In implementations, the productivity cut off values may be based on a minimum permeability value corresponding to a productivity threshold.

In implementations, the permeability values may specify a capacity of a subsurface region to transmit a fluid.

In implementations, the target well and the other potential wells form a pre-configured layout in the subsurface volume of interest.

In implementations, productivity values derived from the estimated reservoir volumes may be used to generate the extraction interference probability.

In implementations, the well implementation data may include one of a well location, a well spacing, and a well geometry.

In implementations, the extraction interference probability may include one of a P10 value, a P50 value, and a P90 value.

In implementations, the well overlap between the target well and the other potential wells may include a shared region between two adjacent wells.

An aspect of the present disclosure relates to a system for estimating well interference on a target well from other potential wells in a subsurface volume of interest. The system may include a graphical user interface and non-transient electronic storage. The system may also include a physical computer processor configured by machine readable instructions to perform a number of steps. One step may include obtaining well implementation data for the target well and the other potential wells in the subsurface volume of interest. Another step may include obtaining estimated reservoir volumes as a function of position in the subsurface volume of interest. Yet another step may include generating well overlap between the target well and the other potential wells based on at least the well implementation data. Another step may include generating extraction interference probabilities based on at least the estimated reservoir volumes and the well overlap. The extraction interference probabilities may each specify an effect one or more of the other potential wells have on productivity of the target well. Yet another step may include generating a representation of a well layout as a function of position in the subsurface volume of interest using visual effects to depict at least a portion of one of the well implementation data, estimated reservoir volumes, and well overlap. The well layout may correspond to one of the extraction interference probabilities that is below an interference threshold. Another step may include displaying the representation.

In implementations, the estimated reservoir volumes may be generated based on at least productivity cut off values and permeability values for the target well and the other potential wells in the subsurface volume of interest.

In implementations, the productivity cut off values may be based on a minimum permeability value corresponding to a productivity threshold.

In implementations, the permeability values may specify a capacity of a subsurface region to transmit a fluid.

In implementations, the target well and the other potential wells may form a pre-configured layout in the subsurface volume of interest.

In implementations, productivity values derived from the estimated reservoir volumes may be used to generate the extraction interference probability.

In implementations, the well implementation data may include one of a well location, a well spacing, and a well geometry.

In implementations, the extraction interference probability may include one of a P10 value, a P50 value, and a P90 value.

In implementations, the well overlap between the target well and the other potential wells may include a shared region between two adjacent wells.

An aspect of the present disclosure relates to a non-transitory computer-readable medium storing instructions for estimating well interference on a target well from other potential wells in a subsurface volume of interest. The instructions may be configured to, when executed, perform a number of steps. One step may include obtaining well implementation data for the target well and the other potential wells in the subsurface volume of interest. Another step may include obtaining estimated reservoir volumes as a function of position in the subsurface volume of interest. Yet another step may include generating well overlap between the target well and the other potential wells based on at least the well implementation data. Another step may include generating extraction interference probabilities based on at least the estimated reservoir volumes and the well overlap. The extraction interference probabilities may each specify an effect one or more of the other potential wells have on productivity of the target well. Yet another step may include generating a representation of a well layout as a function of position in the subsurface volume of interest using visual effects to depict at least a portion of one of the well implementation data, estimated reservoir volumes, and well overlap. The well layout may correspond to one of the extraction interference probabilities that is below an interference threshold. Another step may include displaying the representation.

In implementations, the estimated reservoir volumes may be generated based on at least productivity cut off values and permeability values for the target well and the other potential wells in the subsurface volume of interest.

In implementations, the productivity cut off values may be based on a minimum permeability value corresponding to a productivity threshold.

In implementations, the permeability values may specify a capacity of a subsurface region to transmit a fluid.

In implementations, the target well and the other potential wells may form a pre-configured layout in the subsurface volume of interest.

In implementations, productivity values derived from the estimated reservoir volumes may be used to generate the extraction interference probability.

In implementations, the well implementation data may include one of a well location, a well spacing, and a well geometry.

In implementations, the extraction interference probability may include one of a P10 value, a P50 value, and a P90 value.

In implementations, the well overlap between the target well and the other potential wells may include a shared region between two adjacent wells.

These and other features, and characteristics of the present technology, as well as the methods of operation and functions of the related elements of structure and the combination of parts and economies of manufacture, will become more apparent upon consideration of the following description and the appended Claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the presently disclosed technology. As used in the specification and in the Claims, the singular form of “a”, “an”, and “the” include plural referents unless the context clearly dictates otherwise.

The technology disclosed herein, in accordance with one or more various implementations, is described in detail with reference to the following figures. The drawings are provided for purposes of illustration only and merely depict typical or example implementations of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

### BRIEF DESCRIPTION OF THE DRAWINGS

FIG. 1 shows a system configured for estimating well interference on a target well from other potential wells in a subsurface volume of interest, in accordance with one or more implementations.

FIG. 2 illustrates a method for estimating well interference on a target well from other potential wells in a subsurface volume of interest, in accordance with one or more implementations.

FIG. 3 illustrates an example well layout in the subsurface volume of interest.

FIG. 4 illustrates a gun barrel view of an example well layout in the subsurface volume of interest.

FIG. 5 illustrates examples of stimulation of wells in a subsurface volume of interest, in accordance with one or more implementations.

FIG. 6 illustrates examples of stimulation of wells in a subsurface volume of interest, in accordance with one or more implementations.

FIG. 7 illustrates example extraction interference probabilities between a target well and one or more other potential wells, in accordance with one or more implementations.

FIG. 8 illustrates example computing component, in accordance with one or more implementations.

### DETAILED DESCRIPTION

Existing approaches to develop unconventional reservoirs may require determining how many wells should be in a reservoir and the layout of the wells in the reservoir. For example, wells in these unconventional reservoirs need to be close enough to maximize resource recovery, while they should be far enough away from each other to avoid too much interference. Existing approaches fail to provide an efficient and reliable technology to quantify such interference and to guide development strategy. Existing approaches may use fracture simulators combined with reservoirs simulators to arrive at potential development strategies. However, these approaches take a long time and are usually unable to process a large number of wells due to millions of cells that need to be covered, leading to prohibitive simulation time. These factors also make it unfeasible to explore a probabilistic range of outcomes.

The presently disclosed technology is based on a deep-learning model that reliably predicts the post-fracturing permeability field to predict the interference of additional wells on productivity. The presently disclosed technology also drastically speeds up the prediction process for development strategies and well interference and provides a probability range of interferences. In one example, given the nature of low permeability in shale and tight reservoirs, the simulated permeability volume may contribute to most of the production. Different shapes of wells in the simulated reservoir, corresponding to P10, P50, and P90 scenarios, for example, are identified with the basis of deep-learning permeability fields, existing reservoir properties, and effectiveness of a permeability threshold for multi-phase flow. Well performance of a single well may be estimated based on internal calibration knowledge (e.g., permeability fields, cut-off values, stimulated reservoir volumes, productivity values, etc.). If multiple wells are placed in the reservoir, the shared region among different wells may be identified and calculated. Interference may be obtained through a volume in the multiple wells scenario, which may exclude any overlap between wells, divided by the volume in a single well scenario. A range of probabilities may be based on P10, P50 and P90 values. While delivering a similar level of quality with the traditional workflow, the presently disclosed technology significantly reduces the cycle time from several weeks to several hours (˜95% improvement in efficiency).

Disclosed below are methods, systems, and computer readable storage media that may estimate well interference on a target well from other potential wells in a subsurface volume of interest.

Reference will now be made in detail to various implementations, examples of which are illustrated in the accompanying drawings. In the following detailed description, numerous details may be set forth in order to provide a thorough understanding of the present disclosure and the implementations described herein. However, implementations described herein may be practiced without such details. In other instances, some methods, procedures, components, and mechanical apparatuses may not be described in detail, so as not to unnecessarily obscure aspects of the implementations.

The presently disclosed technology includes implementations of a method, system, and non-transitory computer-readable medium for estimating well interference on a target well from other potential wells in a subsurface volume of interest. The presently disclosed technology may be able to improve extraction efficiency in a subsurface volume of interest by identifying well implementations that reduce interference with other wells. The subsurface volume of interest may include any area, region, and/or volume underneath a surface. Such a volume may include, or be bounded by, one or more of a water surface, a ground surface, and/or other surfaces. The presently disclosed technology may provide a reliable estimate of the amount of production that decreases as a result of neighboring well interference, which is critical to an economic analysis of a subsurface volume of interest. Developers need to minimize the well drilling and completion costs by reducing the number of wells while maximizing recovery. Existing techniques take too long and consume too many resources. These existing techniques take even more time when considering any uncertainty involved with interference. The presently disclosed technology is capable of significantly decreasing the time used to generate estimates and to generate corresponding uncertainty with similar results to existing technologies.

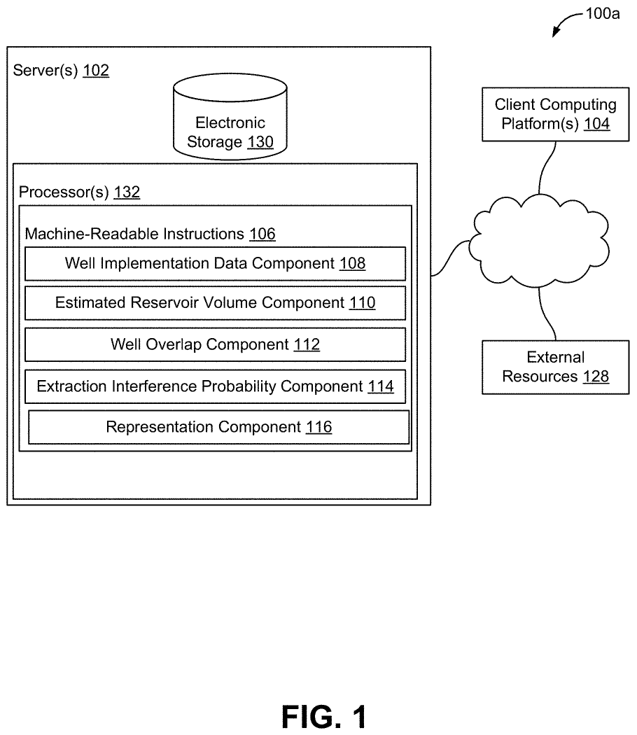

FIG. 1 illustrates a system 100 configured for estimating well interference on a target well from other potential wells in a subsurface volume of interest, in accordance with one or more implementations. In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Machine-readable instructions 106 may include one or more instruction components. The instruction components may include computer program components. The instruction components may include one or more of a well implementation data component 108, an estimated reservoir volume component 110, a well overlap component 112, an extraction interference probability component 114, a representation component 116, and/or other instruction components.

Well implementation data component 108 may be configured to obtain well implementation data. The well implementation data may be obtained from the non-transitory storage medium and/or other sources. The well implementation data may correspond to a target well or other potential wells nearby the target well. In some implementations, some of the other potential well may not be directly next to the target well. The well implementation data may include one of a well location, a well spacing, a well geometry, a well trajectory, and a well completion design. Well locations may include geographical coordinates, x-y coordinates, and/or other location information. Well spacing may specify the distances between well locations. Well geometry may refer to the shape of a given well. Well trajectory may refer to the direction a well is drilled. For example, a well trajectory may include a direction, a length, and/or an inclination angle. Well completion design may include well perforation lengths, proppant intensity, fluid types, number of frac stages, stage length, stage spacing, cluster number, cluster spacing, perforation shot spacing, perforation angle, fluid intensity, proppant type, pumping rate, pumping pressure, and/or other well completion designs. It should be appreciated that there are other known elements of well completion designs.

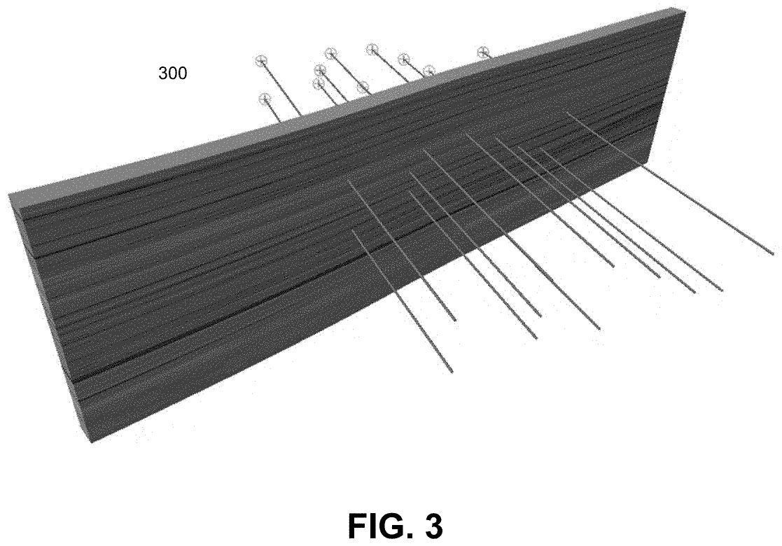

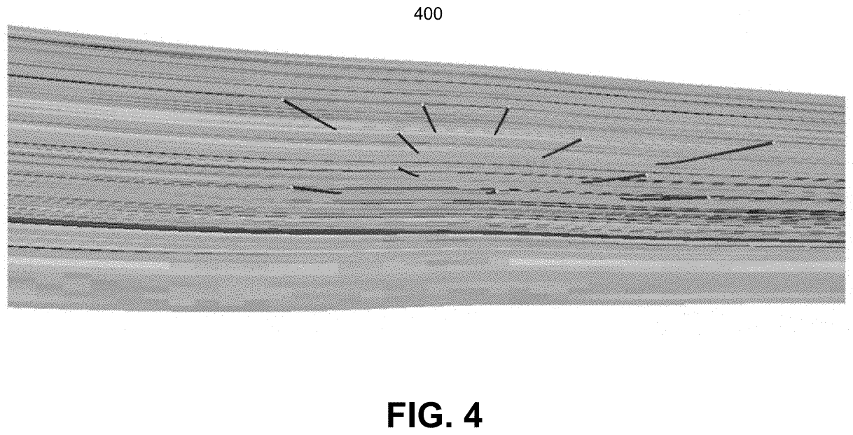

In implementations, the target well and the other potential wells may form a pre-configured layout in the subsurface volume of interest. For example, FIGS. 3 and 4 illustrate two different views of an example layout of eleven wells. 300 may illustrate a perspective view and 400 may illustrate a gun barrel view.

Referring back to FIG. 1, estimated reservoir volume component 110 may be configured to obtain estimated reservoir volumes as a function of position in the subsurface volume of interest. The estimated reservoir volumes may be obtained from the non-transitory storage medium and/or other sources. In implementations, the estimated reservoir volumes may represent a total volume of reservoir that can be hydraulically fractured. In some implementations, the estimated reservoir volumes may be generated based on at least productivity cut off values and permeability values for the target well and the other potential wells in the subsurface volume of interest. The productivity cut off values may be based on a minimum permeability value corresponding to a productivity threshold. The productivity threshold may be an economic value corresponding to costs associated with implementing the wells. The minimum permeability value may correspond to an estimated productivity value that results in an economic value greater than the productivity threshold. In some implementations, the productivity cut off values may be based on the economic value corresponding to the estimated productivity value being greater than the productivity threshold by 10%, 15%, 20%, and so on. In implementations, the permeability values may specify a capacity of a subsurface region to transmit a fluid.

In some implementations, the estimated reservoir volumes can be generated using the following steps. One step may include receiving or obtaining a 3D earth model. Another step may include generating 2D property images from the 3D earth model. The 2D property images may include, for example, porosity, saturation, Poisson's Ratio, and so on. Yet another step may include receiving 2D fracture images. The 2D fracture images may be existing or new simulated 2-D images in X-Z (spatial location-depth) space. Another step may include training a machine learning model using the 2D fracture images. The machine learning model may include a physics-guided neural network (PGNN), DeconvNet, a half convolutional neural network, LeNet without full connection, and/or other machine learning techniques. The input image may undergo convolution, max-pooling, convolution, up-sampling, and/or linear combination. In implementations, the machine learning model may include a convolution network and a deconvolution network performing multiple steps of max-pooling and upsampling. Yet another step may include predicting permeability using the machine learning model applied to the 2D property images.

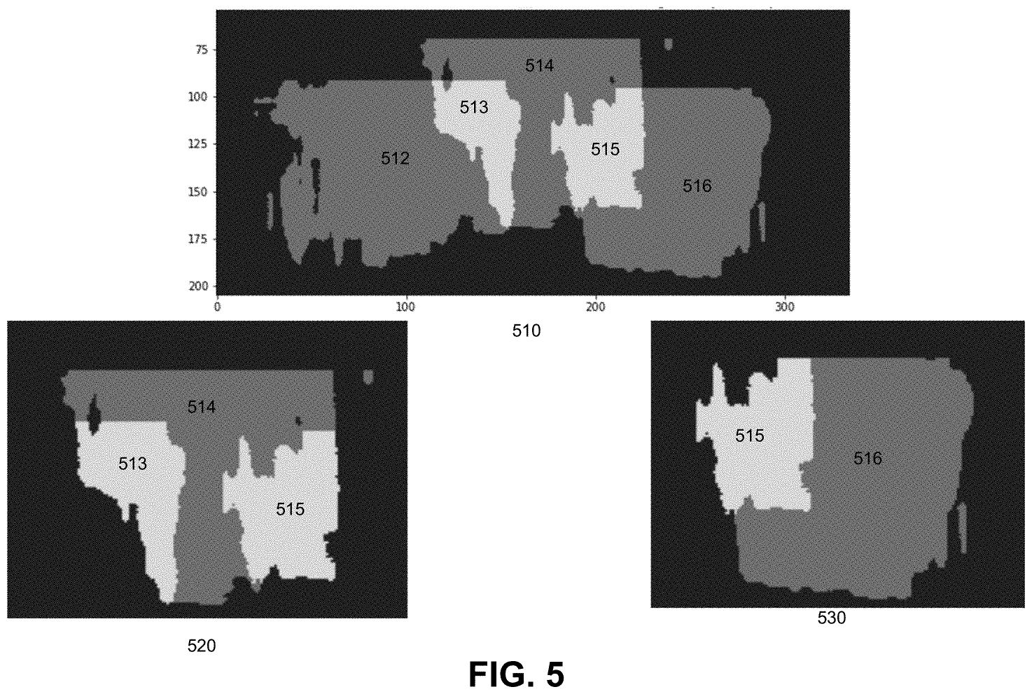

Referring back to FIG. 1, well overlap component 112 may be configured to generate well overlap. This may be accomplished by the physical computer processor. The well overlap may refer to a shared region between two adjacent wells. For example, this region may be the shared region between a target well and one of the other potential wells. In implementations, the region may be the shared stimulated volume between a target well and wells directly surrounding the target well. In some implementations, the target well in a first situation may be one of the other potential wells in a second situation. The well overlap may be viewed from a perspective of the target well or from the perspective of one of the other potential wells. In one example, FIG. 5 illustrates example well overlap between a target well and one or more other potential wells, in accordance with one or more implementations. 510 represents a subsurface volume of interest with region 512, region 513, region 514, region 515, and region 516. Regions 513, 514, and 515 may represent a stimulated portion of a target well and regions 512 and 513 and regions 515 and 516 may represent stimulated portions of other potential wells. Region 513 may represent well overlap between region 512 and region 514, and region 515 may represent well overlap between region 514 and 516. However, it should be appreciated that there may be a situation where region 512 or region 516 represents the stimulated portion of the target well and region 512, region 514, and/or region 516 represent the stimulated portions of the other potential wells. For example, 520 shows regions 513, 514, and 515 and the interference effect from regions 512 and 513 and regions 515 and 516. In another example, 530 shows regions 515 and 516 and the interference effect from regions 513, 514, and 515.

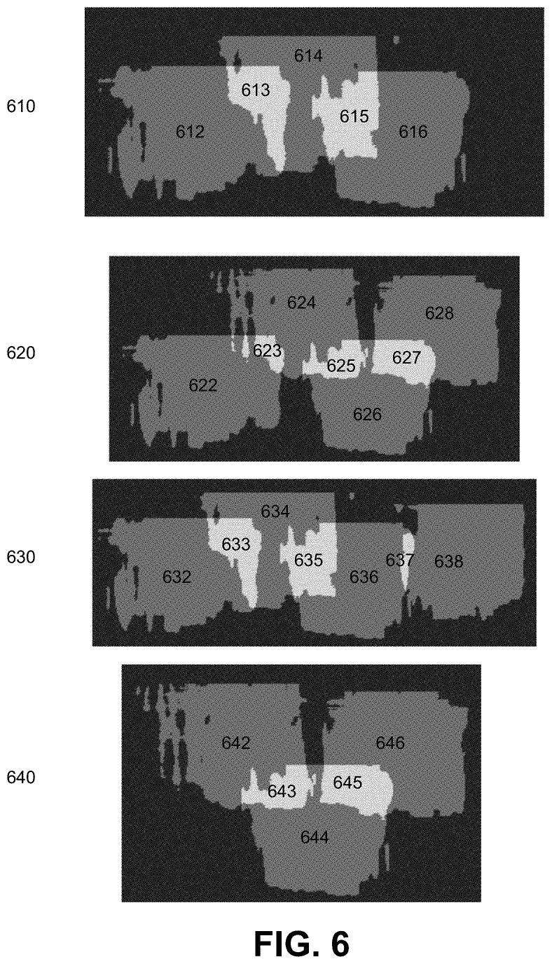

In another example, FIG. 6 illustrates examples of stimulation of wells in a subsurface volume of interest, in accordance with one or more implementations. 610 represents a subsurface volume of interest with three stimulated portions of wells represented by the regions 612, 613, 614, 615, and 616. A first well may be represented by regions 612 and 613, a second well may be represented by regions 613, 614, and 615, and a third well may be represented by regions 615 and 616. Region 613 may represent well overlap between region 612 and region 614, and region 615 may represent well overlap between region 614 and 616. However, it should be appreciated that there may be a situation where regions 612 and 613 or regions 615 and 616 represents the target well and regions 612 and 613, regions 613, 614, and 615, and/or regions 615 and 616 represent the stimulated portions of the other wells. 610 may only represent these three stimulated portions of wells in the entire subsurface volume of interest. As an example, the entire subsurface volume of interest may include the wells represented in 610, 620, 630, and 640.

In contrast to the presently disclosed technology, existing technology requires two different simulations to be run, a fracturing simulation along with a reservoir simulation. Some existing technology may need to run calculations on a cell by cell basis. In some implementations, existing technology may need to run calculations for each well and various combinations of the wells. For example, FIGS. 3 and 4 illustrate two different views of an example layout of eleven wells. 300 may illustrate a perspective view and 400 may illustrate a gun barrel view. Each of the lines in these figures may represent an individual well in the subsurface volume of interest. For a two well scenario, existing technology may first calculate hydrocarbon production for the individual wells. Then, the hydrocarbon production may be calculated for simultaneously draining two adjacent wells. Then, the difference between the simultaneous hydrocarbon production and a sum of the two individual wells is used to determine the interference. For a three well scenario, the difference between the simultaneous hydrocarbon production for three adjacent wells and a sum of the three adjacent wells are used to determine the interference. It should be appreciated that as the number of wells in a scenario increases, the number of calculations increases. In contrast, the presently disclosed technology may rely on an image-based machine learning model (e.g., convolutional neural network) to estimate the well interference. This may include generating a well overlap and/or extraction interference probabilities.

In some implementations, well overlap may be generated based on an overlap of pixels between two wells in a display. In implementations, well overlap may be generated based on a model that can be used to provide a well layout in a subsurface volume. The model may include, for example, location information and well completion design on each individual well and be able to determine the well overlap based on the model.

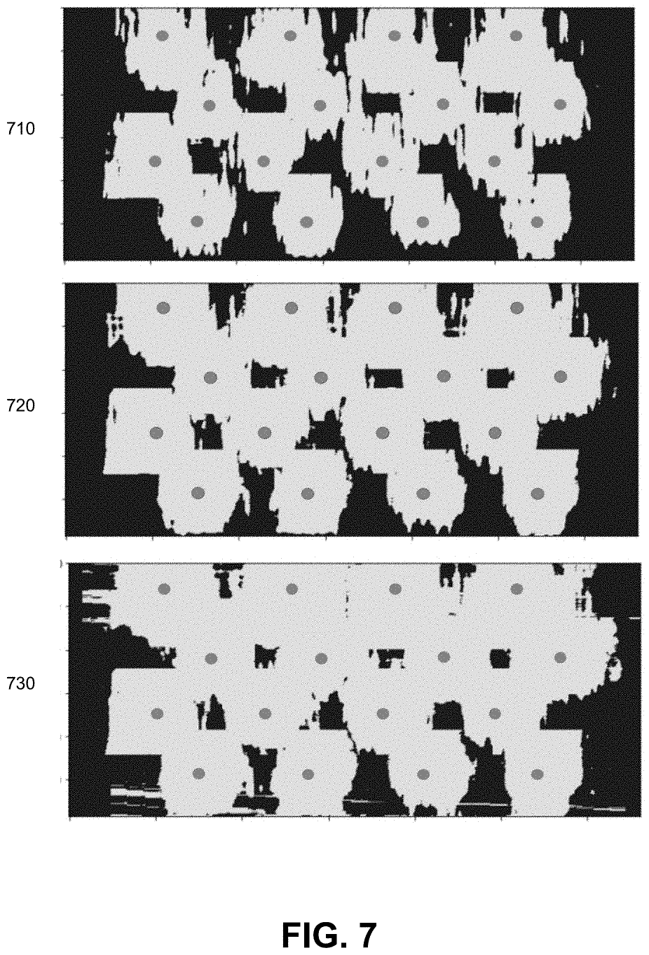

Extraction interference component 114 may be configured to generate extraction interference probabilities. This may be accomplished by the physical computer processor. In implementations, each extraction interference probability may specify an effect one or more of the other potential wells have on productivity of the target well. In some implementations, an extraction interference probability may compare (1) a total productivity of the target well with the other potential wells to (2) a single well productivity of the target well. In some implementations, the extraction interference probabilities may be based on at least the estimated reservoir volumes and the well overlap. For example, an extraction interference probability may be a P10 value of the estimated reservoir volume minus the well overlap. By applying P10-P90 values, a range of probabilities may be generated. Based on this, the extraction interference probabilities may include P10-P90 values. It should be appreciated that depending on the p value, the shape of the stimulated region of the well may change. For example, as illustrated in FIG. 7, 710 illustrates the shapes of the stimulated regions corresponding to P10 values. 720 illustrates the shapes of the stimulated regions corresponding to P50 values, and 730 illustrates the shapes of the stimulated regions corresponding to P90 values. While these three p values are illustrated, it should be appreciated that other p values may be used.

The extraction interference probabilities may be used to select a well layout. In some implementations, the well layout may include multiple wells arranged in the subsurface volume of interest. After generating the extraction interference probabilities, one of the extraction interference probabilities may be below an interference threshold, and the well layout may be used as-is. An interference threshold may depend on the subsurface volume of interest. In some subsurface volumes of interest, the interference threshold may be 50%, 40%, or 30%. In some implementations, the interference threshold may be less than or equal to 80%. In some implementations, the extraction interference probabilities may be above the interference threshold, and another well layout may be used. In implementations, the extraction interference probabilities may be above the interference threshold, and one or more wells in the original well layout may be moved around the subsurface volume of interest, modified, and/or removed from the subsurface volume of interest. The modification may include a change in well geometry, well location, well spacing, a well trajectory, well completion design, and/or other modification.

New extraction interference probabilities may be generated for the modified well layout to determine whether they are below the interference threshold. Once a well layout is selected, the p values applied to the estimated reservoir volume may be used to generate productivity values for the subsurface volume of interest.

Representation component 116 may be configured to generate a representation of a well layout as a function of position in the subsurface volume of interest using visual effects to depict at least a portion of one of the well implementation data, estimated reservoir volumes, extraction interference probabilities, and well overlap. In implementations, the well layout may correspond to one of the extraction interference probabilities that is below an interference threshold. In implementations, a visual effect may include a visual transformation of the representation. A visual transformation may include a visual change in how the representation is presented or displayed. In some implementations, a visual transformation may include a visual zoom, a visual filter, a visual rotation, and/or a visual overlay (e.g., text and/or graphics overlay). The visual effect may include using a temperature map, or other color coding, to indicate which positions in the subsurface volume of interest have higher or lower values.

Representation component 116 may be configured to display the representation. The representation may be displayed on a graphical user interface and/or other displays. For example, FIGS. 3 and 4 may illustrate an example well layout corresponding to an extraction interference probability that is below an interference threshold. FIG. 7 also illustrates an example layout of sixteen wells along with different extraction interference probabilities and corresponding shapes of stimulated regions of the subsurface volume of interest.

In some implementations, server(s) 102, client computing platform(s) 104, and/or external resources 130 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 130 may be operatively linked via some other communication media.

A given client computing platform 104 may include one or more processors configured to execute computer program components. The computer program components may be configured to enable an expert or user associated with the given client computing platform 104 to interface with system 100 and/or external resources 130, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 130 may include sources of information outside of system 100, external entities participating with system 100, and/or other resources. In some implementations, some or all of the functionality attributed herein to external resources 130 may be provided by resources included in system 100.

Server(s) 102 may include electronic storage 132, one or more processors 134, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 132 may include non-transitory storage medium and/or non-transitory storage media that electronically stores information. The electronic storage media of electronic storage 132 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 132 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 132 may include one or more virtual storage resources (e.g., cloud storage, a virtual private network, and/or other virtual storage resources). Electronic storage 132 may store software algorithms, information determined by processor(s) 134, information received from server(s) 102, information received from client computing platform(s) 104, and/or other information that enables server(s) 102 to function as described herein.

Processor(s) 134 may be configured to provide information processing capabilities in server(s) 102. As such, processor(s) 134 may include one or more of a physical computer processor, a digital processor, an analog processor, a digital circuit designed to process information, an analog circuit designed to process information, a state machine, and/or other mechanisms for electronically processing information. Although processor(s) 134 is shown in FIG. 1 as a single entity, this is for illustrative purposes only. In some implementations, processor(s) 134 may include a plurality of processing units. These processing units may be physically located within the same device, or processor(s) 134 may represent processing functionality of a plurality of devices operating in coordination. Processor(s) 134 may be configured to execute components 108, 110, 112, 114, and/or 116, and/or other components. Processor(s) 134 may be configured to execute components 108, 110, 112, 114, and/or 116, and/or other components by software; hardware; firmware; some combination of software, hardware, and/or firmware; and/or other mechanisms for configuring processing capabilities on processor(s) 134. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, and/or 116 are illustrated in FIG. 1 as being implemented within a single processing unit, in implementations in which processor(s) 134 includes multiple processing units, one or more of components 108, 110, 112, 114, and/or 116 may be implemented remotely from the other components. The description of the functionality provided by the different components 108, 110, 112, 114, and/or 116 described below is for illustrative purposes, and is not intended to be limiting, as any of components 108, 110, 112, 114, and/or 116 may provide more or less functionality than is described. For example, one or more of components 108, 110, 112, 114, and/or 116 may be eliminated, and some or all of its functionality may be provided by other ones of components 108, 110, 112, 114, and/or 116. As an example, processor(s) 134 may be configured to execute one or more additional components that may perform some or all of the functionality attributed below to one of components 108, 110, 112, 114, and/or 116.

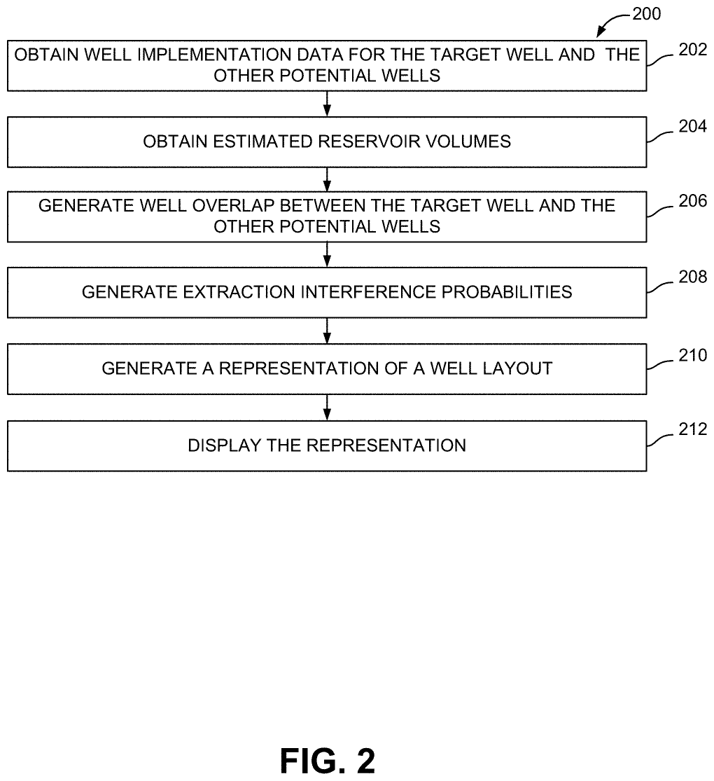

FIG. 2 illustrates a method for estimating well interference on a target well from other potential wells in a subsurface volume of interest, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a physical computer processor, a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

Operation 202 may include obtaining well implementation data for the target well and the other potential wells. The target well and the other potential wells may be in a subsurface volume of interest. The well implementation data may include a well location, a well spacing, a well geometry, a well trajectory, and a well completion design. Operation 202 may be performed by a physical computer processor configured by machine-readable instructions including a component that is the same as or similar to well implementation data component 108 in accordance with one or more implementations.

Operation 204 may include obtaining estimated reservoir volumes. The estimated reservoir volumes may represent a total volume of reservoir that can be hydraulically fractured. In some implementations, the estimated reservoir volumes may be generated based on at least productivity cut off values and permeability values for the target well and the other potential wells in the subsurface volume of interest. The productivity cut off values may be based on a minimum permeability value corresponding to a productivity threshold. The permeability values specify a capacity of a subsurface region to transmit a fluid. Operation 204 may be performed by a physical computer processor configured by machine-readable instructions including a component that is the same as or similar to estimated reservoir volume component 110 in accordance with one or more implementations.

Operation 206 may include generating well overlap between the target well and the other potential wells. The well overlap may refer to a shared region between two adjacent wells. In some implementations, well overlap may be generated based on an overlap of pixels between two wells in a display. In implementations, well overlap may be generated based on a model that can be used to provide a well layout in a subsurface volume. The model may include location information and well completion design on each individual well and be able to determine the well overlap based on the model data. Operation 206 may be performed by a physical computer processor configured by machine-readable instructions including a component that is the same as or similar to well overlap component 112 in accordance with one or more implementations.

Operation 208 may include generating extraction interference probabilities. In implementations, each extraction interference probability may specify an effect one or more of the other potential wells have on productivity of the target well. In some implementations, an extraction interference probability may compare (1) a total productivity of the target well with the other potential wells to (2) a single well productivity of the target well. In some implementations, the extraction interference probabilities may be based on at least the estimated reservoir volumes and the well overlap. The extraction interference probabilities may include P10-P90 values. In some implementations, productivity values derived from the estimated reservoir volumes may be used to generate the extraction interference probability. In some implementations, productivity values may be derived from the extraction interference probability. Operation 208 may be performed by a physical computer processor configured by machine-readable instructions including a component that is the same as or similar to extraction interference probability component 114, in accordance with one or more implementations.

Operation 210 may include generating a representation of a well layout as a function of position in the subsurface volume of interest. The representation may use visual effects to depict at least a portion of one of the well implementation data, estimated reservoir volumes, extraction interference probabilities, and well overlap. In implementations, the well layout may correspond to one of the extraction interference probabilities that is below an interference threshold. The well layout may refer to a layout (e.g., pre-configured or modified) of the target well and the other potential wells in the subsurface volume of interest. Operation 210 may be performed by a physical computer processor configured by machine-readable instructions including a component that is the same as or similar to representation component 116, in accordance with one or more implementations.

Operation 212 may include displaying the representation. Operation 212 may be performed by a physical computer processor configured by machine-readable instructions including a component that is the same as or similar to representation component 116, in accordance with one or more implementations.

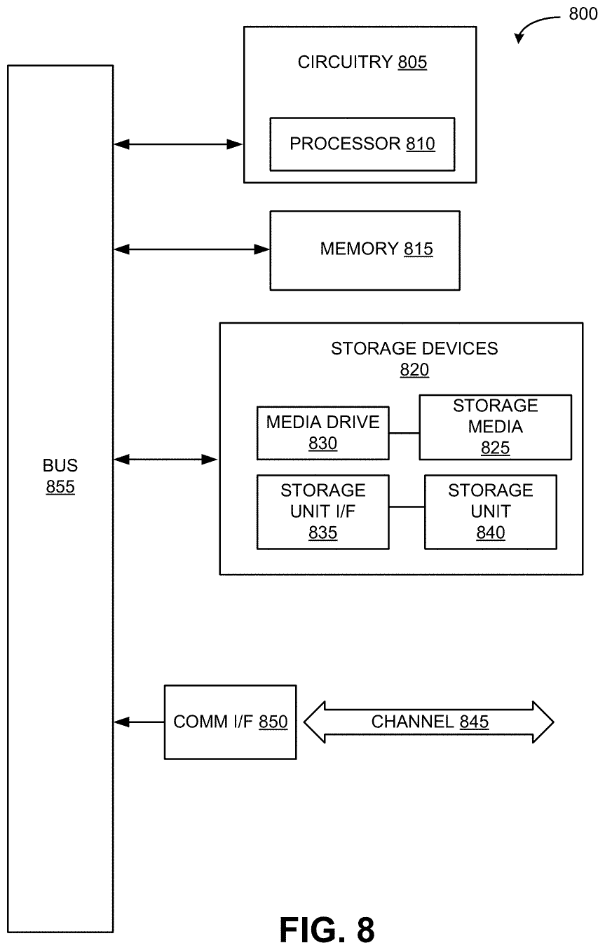

FIG. 8 illustrates example computing component 800, which may in some instances include a processor/controller resident on a computer system (e.g., server system 102). Computing component 800 may be used to implement various features and/or functionality of implementations of the systems, devices, and methods disclosed herein. With regard to the above-described implementations set forth herein in the context of systems, devices, and methods described with reference to FIGS. 1 through 7, including implementations involving server(s) 102, it may be appreciated additional variations and details regarding the functionality of these implementations that may be carried out by computing component 800. In this connection, it will also be appreciated upon studying the present disclosure that features and aspects of the various implementations (e.g., systems) described herein may be implemented with respect to other implementations (e.g., methods) described herein without departing from the spirit of the disclosure.

As used herein, the term component may describe a given unit of functionality that may be performed in accordance with some implementations of the present application. As used herein, a component may be implemented utilizing any form of hardware, software, or a combination thereof. For example, a processor, controller, ASIC, PLA, PAL, CPLD, FPGA, logical component, software routine, or other mechanism may be implemented to make up a component. In implementation, the various components described herein may be implemented as discrete components or the functions and features described may be shared in part or in total among components. In other words, it should be appreciated that after reading this description, the various features and functionality described herein may be implemented in any given application and may be implemented in separate or shared components in various combinations and permutations. Even though various features or elements of functionality may be individually described or claimed as separate components, it will be appreciated that upon studying the present disclosure that these features and functionality may be shared among a common software and hardware element, and such description shall not require or imply that separate hardware or software components are used to implement such features or functionality.

Where components of the application are implemented in whole or in part using software, in implementations, these software elements may be implemented to operate with a computing or processing component capable of carrying out the functionality described with respect thereto. One such example computing component is shown in FIG. 8. Various implementations are described in terms of example computing component 800. After reading this description, it will be appreciated how to implement example configurations described herein using other computing components or architectures.

Referring now to FIG. 8, computing component 800 may represent, for example, computing or processing capabilities found within mainframes, supercomputers, workstations or servers; desktop, laptop, notebook, or tablet computers; hand-held computing devices (tablets, PDA's, smartphones, cell phones, palmtops, etc.); or the like, depending on the application and/or environment for which computing component 800 is specifically purposed.

Computing component 800 may include, for example, a processor, controller, control component, or other processing device, such as a processor 810, and such as may be included in circuitry 805. Processor 810 may be implemented using a special-purpose processing engine such as, for example, a microprocessor, controller, or other control logic. In the illustrated example, processor 810 is connected to bus 855 by way of circuitry 805, although any communication medium may be used to facilitate interaction with other components of computing component 800 or to communicate externally.

Computing component 800 may also include a memory component, simply referred to herein as main memory 815. For example, random access memory (RAM) or other dynamic memory may be used for storing information and instructions to be executed by processor 810 or circuitry 805. Main memory 815 may also be used for storing temporary variables or other intermediate information during execution of instructions to be executed by processor 810 or circuitry 805. Computing component 800 may likewise include a read only memory (ROM) or other static storage device coupled to bus 855 for storing static information and instructions for processor 810 or circuitry 805.

Computing component 800 may also include various forms of information storage devices 820, which may include, for example, media drive 830 and storage unit interface 835. Media drive 830 may include a drive or other mechanism to support fixed or removable storage media 825. For example, a hard disk drive, a floppy disk drive, a magnetic tape drive, an optical disk drive, a CD or DVD drive (R or RW), or other removable or fixed media drive may be provided. Accordingly, removable storage media 825 may include, for example, a hard disk, a floppy disk, magnetic tape, cartridge, optical disk, a CD or DVD, or other fixed or removable medium that is read by, written to, or accessed by media drive 830. As these examples illustrate, removable storage media 825 may include a computer usable storage medium having stored therein computer software or data.

In alternative implementations, information storage devices 820 may include other similar instrumentalities for allowing computer programs or other instructions or data to be loaded into computing component 800. Such instrumentalities may include, for example, fixed or removable storage unit 840 and storage unit interface 835. Examples of such removable storage units 840 and storage unit interfaces 835 may include a program cartridge and cartridge interface, a removable memory (for example, a flash memory or other removable memory component) and memory slot, a PCMCIA slot and card, and other fixed or removable storage units 840 and storage unit interfaces 835 that allow software and data to be transferred from removable storage unit 840 to computing component 800.

Computing component 800 may also include a communications interface 850. Communications interface 850 may be used to allow software and data to be transferred between computing component 800 and external devices. Examples of communications interface 850 include a modem or softmodem, a network interface (such as an Ethernet, network interface card, WiMedia, IEEE 802.XX, or other interface), a communications port (such as for example, a USB port, IR port, RS232 port Bluetooth® interface, or other port), or other communications interface. Software and data transferred via communications interface 850 may typically be carried on signals, which may be electronic, electromagnetic (which includes optical) or other signals capable of being exchanged by a given communications interface 850. These signals may be provided to/from communications interface 850 via channel 845. Channel 845 may carry signals and may be implemented using a wired or wireless communication medium. Some non-limiting examples of channel 845 include a phone line, a cellular or other radio link, an RF link, an optical link, a network interface, a local or wide area network, and other wired or wireless communications channels.

In this document, the terms “computer program medium” and “computer usable medium” are used to generally refer to transitory or non-transitory media such as, for example, main memory 815, storage unit interface 835, removable storage media 825, and channel 845. These and other various forms of computer program media or computer usable media may be involved in carrying a sequence of instructions to a processing device for execution. Such instructions embodied on the medium, are generally referred to as “computer program code” or a “computer program product” (which may be grouped in the form of computer programs or other groupings). When executed, such instructions may enable the computing component 800 or a processor to perform features or functions of the present application as discussed herein.

Various implementations have been described with reference to specific example features thereof. It will, however, be evident that various modifications and changes may be made thereto without departing from the broader spirit and scope of the various implementations as set forth in the appended claims. The specification and figures are, accordingly, to be regarded in an illustrative rather than a restrictive sense.

Although described above in terms of various example implementations and implementations, it should be understood that the various features, aspects, and functionality described in one of the individual implementations are not limited in their applicability to the particular implementation with which they are described, but instead may be applied, alone or in various combinations, to other implementations of the present application, whether or not such implementations are described and whether or not such features are presented as being a part of a described implementation. Thus, the breadth and scope of the present application should not be limited by any of the above-described example implementations.

Terms and phrases used in the present application, and variations thereof, unless otherwise expressly stated, should be construed as open ended as opposed to limiting. As examples of the foregoing: the term “including” should be read as meaning “including, without limitation,” or the like; the term “example” is used to provide illustrative instances of the item in discussion, not an exhaustive or limiting list thereof; the terms “a” or “an” should be read as meaning “at least one,” or the like; and adjectives such as “standard,” “known,” and terms of similar meaning should not be construed as limiting the item described to a given time period or to an item available as of a given time, but instead should be read to encompass standard technologies that may be available or known now or at any time in the future. Likewise, where this document refers to technologies that would be appreciated to one of ordinary skill in the art, such technologies encompass that which would be appreciated by the skilled artisan now or at any time in the future.

The presence of broadening words and phrases such as “at least,” “but not limited to,” or other like phrases in some instances shall not be read to mean that the narrower case is intended or required in instances where such broadening phrases may be absent. The use of the term “component” does not imply that the components or functionality described or claimed as part of the component are all configured in a common package. Indeed, any or all of the various components of a component, whether control logic or other components, may be combined in a single package or separately maintained and may further be distributed in multiple groupings or packages or across multiple locations.

Additionally, the various implementations set forth herein are described in terms of example block diagrams, flow charts, and other illustrations. As will be appreciated after reading this document, the illustrated implementations and their various alternatives may be implemented without confinement to the illustrated examples. For example, block diagrams and their accompanying description should not be construed as mandating a particular architecture or configuration.

What is claimed is:

1. A computer-implemented method for estimating well interference on a target well from other potential wells in a subsurface volume of interest, the method being implemented in a computer system that includes a physical computer processor, a graphical user interface, and non-transient electronic storage, the method comprising:
obtaining well implementation data for the target well and the other potential wells in the subsurface volume of interest from the non-transient electronic storage;
obtaining estimated reservoir volumes as a function of position in the subsurface volume of interest from the non-transient electronic storage;
generating, with the physical computer processor, well overlap between the target well and the other potential wells based on at least the well implementation data; and
generating, with the physical computer processor, extraction interference probabilities based on at least the estimated reservoir volumes and the well overlap, wherein the extraction interference probabilities each specify an effect one or more of the other potential wells have on productivity of the target well;
generating, with the physical computer processor, a representation of a well layout as a function of position in the subsurface volume of interest using visual effects to depict at least a portion of one of the well implementation data, estimated reservoir volumes, and well overlap, wherein the well layout corresponds to one of the extraction interference probabilities that is below an interference threshold; and
displaying the representation in the graphical user interface.

2. The computer-implemented method of claim 1, wherein the estimated reservoir volumes are generated based on at least productivity cut off values and permeability values for the target well and the other potential wells in the subsurface volume of interest.

3. The computer-implemented method of claim 2, wherein the productivity cut off values are based on a minimum permeability value corresponding to a productivity threshold.

4. The computer-implemented method of claim 2, wherein the permeability values specify a capacity of a subsurface region to transmit a fluid.

5. The computer-implemented method of claim 1, wherein the target well and the other potential wells form a pre-configured layout in the subsurface volume of interest.

6. The computer-implemented method of claim 1, wherein productivity values derived from the estimated reservoir volumes are used to generate the extraction interference probability.

7. The computer-implemented method of claim 1, wherein the well implementation data comprises one of a well location, a well spacing, and a well geometry.

8. The computer-implemented method of claim 1, wherein the extraction interference probability comprises one of a P10 value, a P50 value, and a P90 value.

9. The computer-implemented method of claim 1, wherein the well overlap between the target well and the other potential wells comprises a shared region between two adjacent wells.

10. A system comprising:
a graphical user interface;
non-transitory storage medium; and
a physical computer processor configured by machine-readable instructions to:
obtain well implementation data for the target well and the other potential wells in the subsurface volume of interest from the non-transient electronic storage;
obtain estimated reservoir volumes as a function of position in the subsurface volume of interest from the non-transient electronic storage;
generate, with the physical computer processor, well overlap between the target well and the other potential wells based on at least the well implementation data; and
generate, with the physical computer processor, extraction interference probabilities based on at least the estimated reservoir volumes and the well overlap, wherein the extraction interference probabilities each specify an effect one or more of the other potential wells have on productivity of the target well;
generate, with the physical computer processor, a representation of a well layout as a function of position in the subsurface volume of interest using visual effects to depict at least a portion of one of the well implementation data, estimated reservoir volumes, and well overlap, wherein the well layout corresponds to one of the extraction interference probabilities that is below an interference threshold; and
display the representation in the graphical user interface.

11. The system of claim 10, wherein the estimated reservoir volumes are generated based on at least productivity cut off values and permeability values for the target well and the other potential wells in the subsurface volume of interest.

12. The system of claim 11, wherein the productivity cut off values are based on a minimum permeability value corresponding to a productivity threshold.

13. The system of claim 11, wherein the permeability values specify a capacity of a subsurface region to transmit a fluid.

14. The system of claim 10, wherein the target well and the other potential wells form a pre-configured layout in the subsurface volume of interest.

15. The system of claim 10, wherein productivity values derived from the estimated reservoir volumes are used to generate the extraction interference probability.

16. The system of claim 10, wherein the well implementation data comprises one of a well location, a well spacing, and a well geometry.

17. The system of claim 10, wherein the extraction interference probability comprises one of a P10 value, a P50 value, and a P90 value.

18. The system of claim 10, wherein the well overlap between the target well and the other potential wells comprises a shared region between two adjacent wells.

19. A non-transitory computer-readable medium storing instructions for estimating well interference on a target well from other potential wells in a subsurface volume of interest, the instructions configured to, when executed:
obtain well implementation data for the target well and the other potential wells in the subsurface volume of interest from non-transient electronic storage;
obtain estimated reservoir volumes as a function of position in the subsurface volume of interest from the non-transient electronic storage;
generate, with a physical computer processor, well overlap between the target well and the other potential wells based on at least the well implementation data; and
generate, with the physical computer processor, extraction interference probabilities based on at least the estimated reservoir volumes and the well overlap, wherein the extraction interference probabilities each specify an effect one or more of the other potential wells have on productivity of the target well;
generate, with the physical computer processor, a representation of a well layout as a function of position in the subsurface volume of interest using visual effects to depict at least a portion of one of the well implementation data, estimated reservoir volumes, and well overlap, wherein the well layout corresponds to one of the extraction interference probabilities that is below an interference threshold; and
display the representation in a graphical user interface.

20. The non-transitory computer-readable medium of claim 19, wherein the estimated reservoir volumes are generated based on at least productivity cut off values and permeability values for the target well and the other potential wells in the subsurface volume of interest.
